(19) United States
(12) Patent Application Publication
(10) Pub. No.: US 2019/0143349 A1
(43) Pub. Date: May 16, 2019

(54) Device and Method for Distributing Chemicals Into the Air Via a Fan

(71) Applicant: Dust Control Technology, Inc., Peoria, IL (US)

(72) Inventors: Michael Edward Lewis, Peoria, IL (US); Jason Lesch, Peoria, IL (US)

(21) Appl. No.: 16/188,616

(22) Filed: Nov. 13, 2018

Related U.S. Application Data
(60) Provisional application No. 62/586,264, filed on Nov. 15, 2017.

(51) Int. Cl. B05B 3/02; B05B 3/08; B05B 12/06; B05B 1/08; E21F 5/06

(52) U.S. Cl. CPC B05B 3/022; B05B 3/087; E21F 5/06; B05B 1/083; B05B 12/06

(57) ABSTRACT

A chemical discharging fan system has a ducted fan adapted and configured to generate a flow of air from an inlet of the fan into a duct of the fan and through the outlet of the fan. A spray gun is arranged on the fan in the flow of the air generated by the fan. The spray gun has a fluid inlet adapted and configured to receive a pressurized fluid from a fluid supply source. The spray gun is configured to intermittently discharge the fluid from the fluid source into the flow of air generated by the fan. A control is in communication with the spray gun. The control is configured to generate a pulse width modulated signal to cycle the spray gun, which causes the fluid to vaporize upon being discharged from the spray gun into the flow of air generated by the fan.

### RELATED APPLICATION DATA

This application claims the benefit of provisional application Ser. No. 62/586,264, filed Nov. 15, 2017, the disclosure of which is incorporated by reference herein.

### BACKGROUND

It is known to use fans, typically ducted fans, to disperse liquids (e.g. water) into the air. For example, it is known to provide a system comprising a ducted fan, a source of water, a pump, and nozzle system, whereby the pump is configured to force the water through the nozzle system into the air stream generated by the fan to thereby create an airstream comprising a mist of water. Such assemblies are known to be useful in controlling/limiting dust at/around industrial sites when dust generation is a concern. Still further, there are trailer mounted versions of such assemblies that are capable of dispensing an airstream laden with liquid droplets distances of over one hundred meters and include a generator, thereby eliminating any need to power the systems from external power supplies. The directional control of the airstream relative to the trailer can also be controlled via power driven articulation associated with the fan. In some cases, a trailer can also be provided with a tank of water or other liquid, thereby making such systems operable without connection to an external source of water/liquid.

Aside from dust control, there is a need in particular industries to reduce or minimize the odors emitted from particular activities. Particular chemicals are known to bond with particular other chemicals known to be odorously offensive to humans. Thus, dispersing such chemicals when and where such activities occur can reduce or minimize odorous emissions of such activities.

### SUMMARY

The present disclosure is directed to using a fan system with associated power and support equipment to dispense airstreams containing such chemicals in vapor (i.e., gaseous) form, as opposed to diluted liquid droplets suspensions. Such a system comprises a high pressure pump and nozzle configured for such pressure to vaporize chemicals from liquid to gas and dispense a stream of air comprising such vaporized chemicals. As opposed to the prior systems that dispense droplets of water in the air stream, the present disclosure is directed to discharging the liquid chemical mixture for dust or odor control through a fine nozzle under a sufficiently high pressure to cause the chemical mixture to vaporize upon discharge from the nozzle and mixing with the stream of air from the ducted fan. This eliminates any need to provide a carrier dilutant such as water to dilute such chemicals for dispersion as a mist. The need to supply such a system with water from a tank or external source can thereby be eliminated. As a result, the run-time and/or mobility of such a new system is greatly enhanced. Alternatively, the weight capacity of trailers provided with the system can be decreased, if desire, by a decrease in the gross weight eliminated by any dilution water required. The disclosure provides a unique way of dispensing chemicals from concentrate over substantial distances, and optionally on mobile platforms such as trailers.

In one aspect of the disclosure, a system comprises a fan and a high pressure pump combined with a nozzle designed to vaporize liquid chemicals and introduce the same into the airstream created by the fan. The system could optionally be mounted on a trailer or truck for mobility, which could include a generator so as to be completely operable independent of external supply. The system is not limited to being use connection with odor eliminating chemicals, but also applies to the dispersion of any chemical in vapor form, as opposed to suspended droplets, via a ducted fan.

### DESCRIPTION OF THE DRAWING

FIG. 1 shows a perspective view of an exemplary trailer mounted chemical discharging fan system comprising a generator arranged adjacent a tongue of the trailer and a ducted fan mounted on a support structure that surrounds a heated enclosure with a chemical container enclosed in the heated enclosure shown in phantom.

FIG. 2 is a partial perspective view of a fan showing a spray gun and the direction of air flow from the fan.

FIG. 3 is a schematic diagram of the system.

FIG. 4 shows a perspective view of a spray gun of the ducted fan.

FIG. 5 shows an enlarged, partial view of the nozzle and spray pattern from the spray gun of FIG. 4.

FIG. 6 shows a graph correlating duty cycle with frequency and spray gun cycle rates.

### DETAILED DESCRIPTION

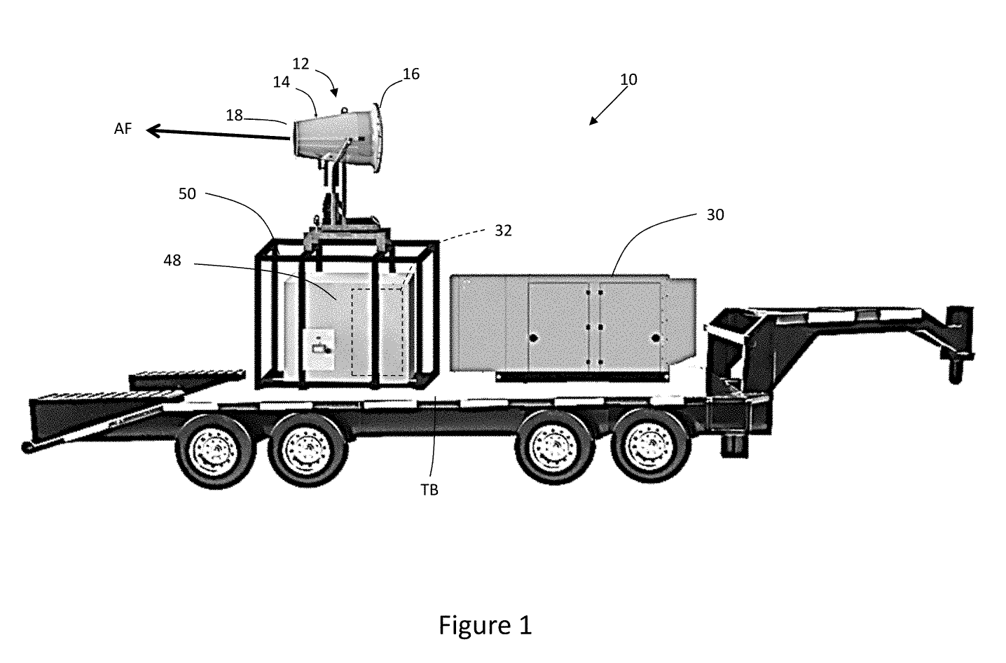

FIG. 1 shows an exemplary chemical discharging fan system 10. The chemical discharging fan system 10 includes a fan 12, for instance, a ducted fan. The ducted fan 12 has a duct 14 comprising an inlet 16 and an outlet 18 spaced from the inlet along a length of the duct of the fan. The ducted fan may contain fan blades 20 operatively connected to a motor 22. The motor 22 may be disposed in the interior of the duct 14. A shaft 24 may directly couple the motor 22 to the blades 20. The blades 20 may be adapted and configured to generate an air flow AF from the inlet 16 of the duct into the interior of the duct and out through the outlet 18.

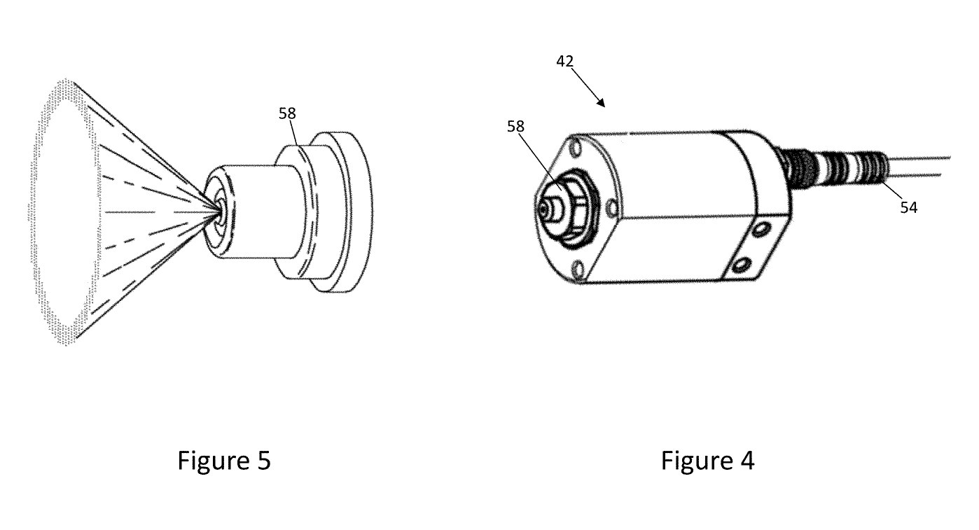

The chemical discharging fan system 10 may include a generator 30 and a chemical container 32. The generator 30 may be used to power the fan 12 and other equipment of the chemical discharging fan system 10. For instance, the generator 30 may supply power to the fan motor 22, a controller 40 and/or a spray gun 42 mounted on the fan, and/or one or more pumps 44,46 associated with the system. The generator 30 may be a gasoline or diesel powered motor driven generator. The generator 30 may be mounted on a trailer as shown in FIG. 1, or may be provided adjacent to the fan, for instance, in a permanent, on-site, non-mobile application. The chemical container 32 may be used as a fluid supply source to supply fluid to the fan as will be described below in greater detail. The chemical container 32 may be contained in an enclosure 48 (FIGS. 1 and 4), which may be heated to facilitate use in cold climates. The chemical container 32 may contain a fluid comprising an odor suppressant or a dust suppressant. By way of example and not in any limiting sense, the generator may be a QP-25 T4F generator supplied by Southwest Products of Surprise, Ariz.; the odor suppressant may be QuikAir™ V Concentrate, supplied by GOC Technologies of Bloomington, Ind., and the fan may be a DB-30 supplied by Dust Control Technologies, Inc. of Peoria, Ill.

As shown in FIG. 1, the fan 12 of the chemical discharging fan system 10 may be mounted to a superstructure 50 of the enclosure 48. The superstructure 50 may be formed within the enclosure 48 or around the enclosure. As shown in FIG. 1, the chemical discharging fan system 10 is placed in line with the power generator 30 on a trailer bed TB, the power generator is arranged adjacent the tongue of the trailer bed, and the chemical container 32 is arranged in the heated enclosure 48 that is positioned toward the rear of the trailer bed with the superstructure 50 formed above and around the enclosure to support the fan 12 and to provide an unobstructed air flow AF discharge from the fan into the atmosphere and an intended target. While the drawings show a mobile platform for the chemical discharging fan system 10, the chemical discharging fan system may also be rigidly mounted to a superstructure located on-site where the chemical discharging fan system will be used. Accordingly, the fan may be mounted on a pole or other superstructure, and the chemical container and generator may be located in close proximity to the fan.

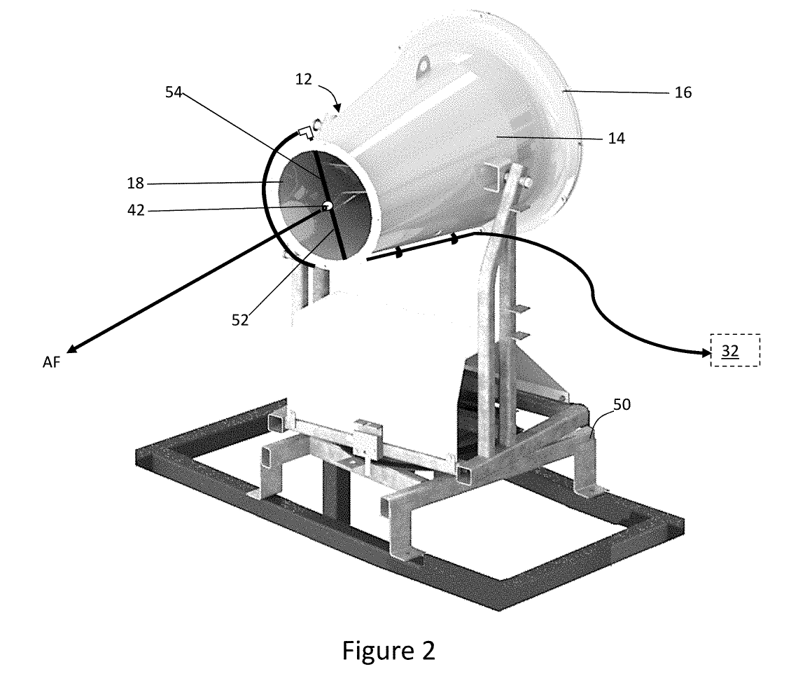

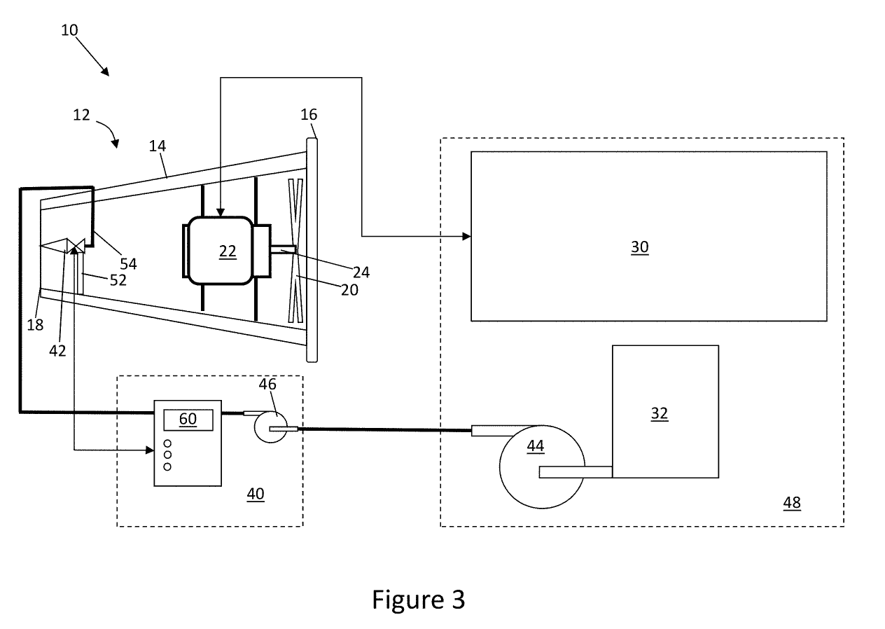

FIGS. 2 and 3 show additional detail of the chemical discharging fan system 10. The chemical discharging fan system 10 may be provided with the spray gun 42 on the fan 12. The spray gun 42 may be arranged in the hollow interior of the ducted fan. The spray gun 42 may be arranged adjacent to the outlet 18 of the fan 12. The spray gun 42 may be supported in the interior of the ducted fan by a bracket 52. The spray gun 42 may have an inlet 54 that is adapted and configured to receive a fluid from the fluid supply source (e.g., the chemical container 32), and the spray gun fluid inlet 54 may together with bracket 52 support the spray gun 42 on the fan 12. As shown in the drawings, the fluid inlet 54 of the spray gun may comprise a piping connection, and the piping connection may in part support the spray gun 42 in the hollow interior of the ducted fan 12 along with the bracket 52.

The fluid supply, for instance, from the chemical container 32, may comprise an odor suppressant or a dust suppressant. The fluid may be drawn from the chemical container 32 by the pump 44 and directed to the fluid inlet 54 of the spray gun 42. In the alternative, the fluid may be drawn from the chemical container 32 with the pump 44 and directed to the booster pump 46, which directs the fluid to the fluid inlet 54 of the spray gun 42. In this way, the fluid directed to the spray gun 42 from the fluid supply source 32 directly comprises the odor suppressant or the dust suppressant chemical and there is no need to supply a separate dilutant (e.g., water) and no need to have the chemical dispensed or suspended in a water carrier. The liquid chemical mixture (e.g., the dust or odor suppressant) may be injected directly to the spray gun 42 under a sufficiently high pressure generated by the booster pump 46 and/or the main pump 44. The high pressure generated by the booster pump 46 and/or the main pump 44 in turn causes the chemical to vaporize upon discharge from the spray gun nozzle 58 into the stream of air AF from the ducted fan. This eliminates any need to dilute the chemicals, and dispenses with the need to supply the system with water from a tank or an external source.

Referring to FIG. 4, the spray gun 42 may be configured to provide an intermittent discharge of high velocity atomized fluid which is immediately vaporized upon the fluid being released from the spray gun into the air stream generated by the fan. In one embodiment, the spray gun 42 may be an electronically activated air atomizing spray gun. The spray gun 42 may be a quick acting fast cycling solenoid actuated spray gun. The spray gun 42 may cycle up to 15,000 times a minute. The spray gun 42 may be configured to receive control signals that are based on frequency and pulse width modulation. The frequency and pulse width modulation may be set in accordance with a desired duty cycle and flow rate. The spray gun cycle duration may be from 6 milliseconds to a continuous spray, depending upon the frequency and pulse width modulation, and desired duty cycle and flow rate, thereby providing the user with flexibility in applications. The spray gun may be a 100000JJAU or a 10000AUH provided by Spraying Systems Company of Wheaton, Ill. Depending upon the application, the fluid supplied to the spray gun may be pressurized. This may dispense with the need to supply pressurized air to the spray gun.

The spray gun 42 may have a nozzle 58 that assists in providing a fine atomized discharge. In one aspect, the nozzle 58 may be configured to generate a hollow cone spray pattern, for instance, as shown in FIG. 5. The nozzle 58 may be integral with the spray gun 42 or removable. The spray angle produced by the nozzle 58 and spray gun 42 may vary depending upon the inlet pressure. For instance, at a 40 psi, the spray angle may be 80°, at 100 psi and greater, the spray angle may be 75°. The nozzle may be selected in accordance with a desired flow rate from the nozzle. For instance, the nozzle may provide 0.71 gallons per hour at 20 psi, 1.0 gallons per hour at 40 psi, 1.6 gallons per hour at 100 psi, 1.9 gallons per hour at 150 psi, and 2.2 gallons per hour at 200 psi. The nozzle may also be sized to provide 1.4 gallons per hour at 20 psi, 2.0 gallons per hour at 40 psi, 3.2 gallons per hour at 100 psi, 3.9 gallons per hour at 150 psi, and 4.5 gallons per hour at 200 psi.

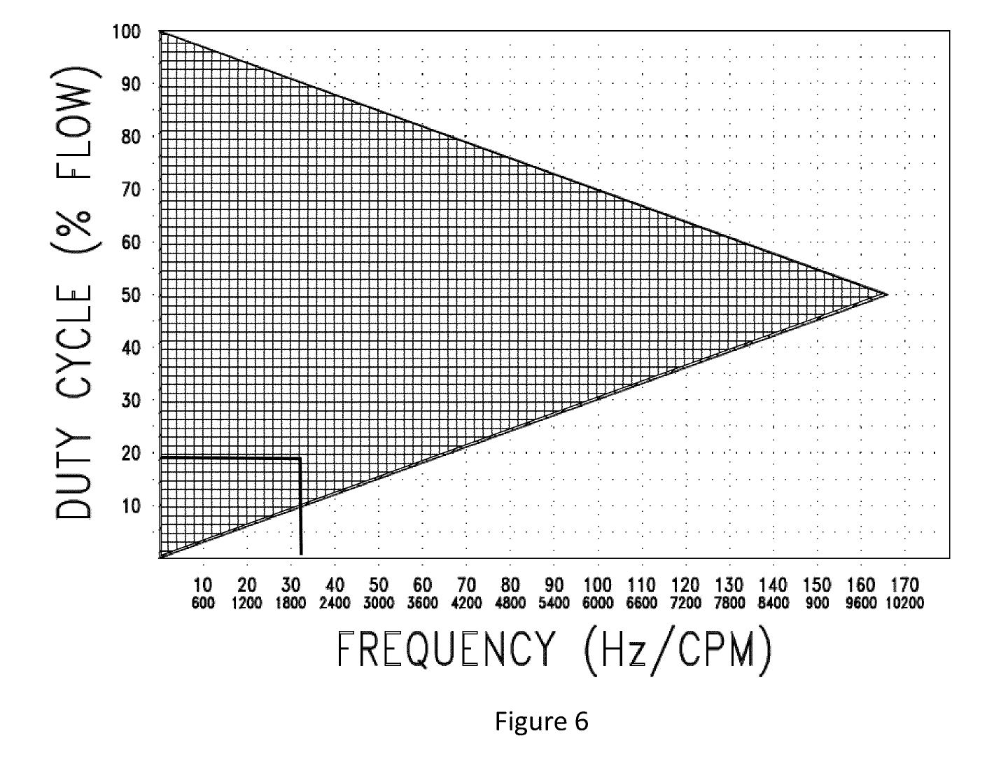

The spray gun 42 may be controlled with the control 40 that is enabled to generate a pulse width modulation signal and/or a variable frequency signal. The control 40 may be adapted and configured to cycle the spray gun at least 1000 times per minute and up to 10,000 times per minute. The control 40 may have an adjustable frequency from 10 Hz to 170 Hz. The control may be a model 1550 AutoJet Modular spray system provided by Spraying Systems Company of Wheaton, Ill. The control 40 may be mounted adjacent to the fan 12 to allow the operator to adjust the desired spray characteristics. The desired spray characteristics may be based upon duty cycle. For instance, the control 40 may be provided with a human machine interface 60 which allows the operator to select a duty cycle, a frequency, and or a cycle rate. The duty cycle may correspond to the number of cycles per minute and/or frequency of the spray gun. The user may select a rate that is anywhere between 1 cycle per minute and 10,000 cycles per minute. FIG. 6 shows an exemplary operating curve correlating duty cycle and frequency and cycle per minute. As shown, a 20% duty cycle (e.g., the spray gun operates 20% of the time relative to a continuous spray) corresponds to roughly 32 Hz and 2000 cycles per minute.

While the drawings show a control and a spray gun with a discharge nozzle attached thereto, the system may be configured with a nozzle with a fluid inlet that receives pressurized fluid from the fluid source. The nozzle may be dimensioned such that for a given pressure of the fluid from the fluid supply source at the fluid inlet to the nozzle, the exit velocity and pressure drop from the nozzle discharge may be sufficient to atomize and cause to vaporize the fluid upon discharge from the nozzle and entry into the air flow generated by the fan. Such an embodiment may dispense with the need to provide a control for the nozzle. Accordingly, the fluid may have constituents that enhance vaporization upon discharge from the nozzle and/or spray gun after pressurization.

In using the chemical discharging fan system 10, the user may align the fluid supply source to the fluid inlet 54 of the spray gun 42, energize the fan 12 to generate the airflow AF through the duct 14 of the fan, and then operate the control 40 to cycle the spray gun at a desired rate, which may be up to 1000 cycles per minute, or at least 1000 cycles per minute. The user may also operate the control 40 to cycle the spray gun as desired, including at a rate of at least 2000 cycles per minute or a rate of at least 5000 cycles per minute. In aligning the fluid supply source to the fluid inlet of the spray gun 42, the operator may energize a pump 44 that draws the fluid directly from the chemical container 32 to the fluid inlet 54 of the spray gun. In addition, or in the alternative, the user may also energize a booster pump 46 that draws fluid from the discharge of the main supply pump 44 and directs the fluid under high pressure to fluid inlet 54 of the spray gun 42. The user may operate the control 40 to set a duty cycle for the spray gun as desired, including at a duty cycle of 10% to 80%. In aligning the fluid from the fluid supply source, the user may provide an odor suppressant fluid or may provide a dust suppressant fluid or a combination. The user may energize a generator 30 to provide power to the control 40 and/or spray gun 42, fan motor 22, and/or pumps 44,46.

In other another aspect of the method, the user may energize the fan to generate the flow of air through the duct of the fan; and direct pressurized fluid from the fluid supply source to the fluid inlet of the nozzle in such a way that the fluid vaporizes upon being discharged from the nozzle into the flow of air generated by the fan. As mentioned above, the nozzle may be dimensioned such that for a given pressure of the fluid from the fluid supply source at the fluid inlet to the nozzle, the exit velocity and pressure drop from the nozzle discharge is sufficient to atomize and cause to vaporize the fluid upon discharge from the nozzle and entry into the air flow generated by the fan.

As various modifications could be made in the constructions and methods herein described without departing from the scope of the invention, it is intended that all matter contained in the foregoing description and shown in the accompanying drawings shall be interpreted as illustrative and not as limiting. The breadth and scope the present invention should not be limited by any of the above described exemplary embodiments.

What is claimed is:

1. A chemical discharging fan system comprising:
a ducted fan adapted and configured to generate a flow of air from an inlet of the fan into a duct of the fan and through the outlet of the fan;
spray gun arranged on the fan in the flow of the air generated by the fan, the spray gun being adapted and configured to intermittently discharge the fluid from the fluid source into the flow of air generated by the fan, the spray gun having a fluid inlet adapted and configured to receive a pressurized fluid from a fluid supply source, the spray gun being adapted and configured to cause the fluid to vaporize upon being discharged from the nozzle into the flow of air generated by the fan; and
a control in communication with the spray gun, the control being adapted and configured to generate a pulse width modulated signal to cycle the spray gun.

2. The chemical discharging fan system of claim 1, wherein the spray gun is adapted and configured to intermittently discharge the fluid from the fluid source into the flow of air generated by the fan at a variable rate; and the control is adapted and configured to cycle the spray gun at the variable rate as selected by a user.

3. The chemical discharging fan system of claim 2, wherein the user selected rate is between 1 cycle per minute and 1,000 cycles per minute.

4. The chemical discharging fan system of claim 1 wherein the spray gun is adapted and configured to intermittently discharge the fluid from the fluid source into the flow of air generated by the fan at a rate of at least 1,000 cycles per minute, and the control is adapted and configured to cycle the spray gun at a rate of at least about 1000 cycles per minute.

5. The chemical discharging fan system of claim 1 wherein the spray gun is adapted and configured to intermittently discharge the fluid from the fluid source into the flow of air generated by the fan at a rate of at least 2,000 cycles per minute; and the control is adapted and configured to cycle the spray gun at a rate of at least 2,000 cycles per minute.

6. The chemical discharging fan system of claim 1 wherein the spray gun is adapted and configured to intermittently spray the fluid from the fluid source into the flow of air generated by the fan at a rate of at least 5,000 cycles per minute; and the control is adapted and configured to cycle the spray gun at a rate of at least 5,000 cycles per minute.

7. The chemical discharging fan system of claim 1 wherein spray gun has a nozzle configured to generate a hollow cone spray pattern.

8. The chemical discharging fan system of claim 1 wherein the spray gun is arranged in a hollow interior of the duct.

9. The chemical discharging fan system of claim 1 wherein the spray gun is arranged adjacent to the outlet of the fan.

10. The chemical discharging fan system of claim 1 further comprising a generator, adapted and configured to supply electrical power to the fan and the control.

11. The chemical discharging fan system of claim 1 further comprising a container for containing the fluid of the fluid supply source.

12. The chemical discharging fan system of claim 11 further comprising a pump adapted and configured to draw the fluid from the container and direct the pressurized fluid to the fluid inlet of the spray gun.

13. A method comprising:
providing a chemical discharging fan system comprising a ducted fan, wherein the fan: (i) has a duct with an inlet and an outlet spaced from the inlet along the duct of the fan; (ii) is configured to generate a flow of air from the inlet into the duct and through the outlet when the fan is energized; and (iii) includes a spray gun arranged on the fan in the flow of the air generated by the fan wherein the spray gun has a fluid inlet adapted and configured to receive a pressurized fluid from a fluid supply source, and the spray gun is in communication with a control and receives pulse width modulated signals from the control enabling the spray gun to intermittently discharge fluid from the fluid source into the flow of air generated by the fan;
energizing the fan to generate the flow of air through the duct of the fan; and
directing the pressurized fluid from the fluid supply source to the fluid inlet of the spray gun; and
operating the control to cycle the spray gun in a manner that the fluid discharged from the spray gun vaporizes upon being discharged from the nozzle into the flow of air generated by the fan.

14. The method of claim 13 wherein the step of operating the control to cycle the spray gun includes varying a rate of intermittent discharge of the spray gun.

15. The method of claim 14 wherein the step of varying the rate includes selecting a rate between 1 cycle per minute and 1,000 cycles per minute.

16. The method of claim 13 wherein the step of operating the control to cycle the spray gun includes operating the control to cycle the spray gun at a rate of at least 1,000 times per minute.

17. The method of claim 13 wherein the step of operating the control to cycle the spray gun includes operating the control to cycle the spray gun at a rate of at least 2,000 times per minute.

18. The method of claim 13 wherein the step of operating the control to cycle the spray gun includes operating the control to cycle the spray gun at a rate of at least 5,000 times per minute.

19. The method of claim 13 wherein the step of directing the fluid from the fluid supply source includes providing an odor suppressant fluid.

20. The method of claim 13 wherein the step of directing the fluid from the fluid supply source includes providing a dust suppressant fluid.
